(19) United States
(12) Patent Application Publication
(10) Pub. No.: US 2013/0104828 A1
(43) Pub. Date: May 2, 2013

(54) ENGINE STARTING DEVICE AND VEHICLE INCORPORATING THE SAME

(71) Applicants: Kouki Moriya, Aichi-gun (JP); Jumpei Kakehi, Toyota-shi (JP); Hasrul Sany Bin Hashim, Toyota-shi (JP)

(72) Inventors: Kouki Moriya, Aichi-gun (JP); Jumpei Kakehi, Toyota-shi (JP); Hasrul Sany Bin Hashim, Toyota-shi (JP)

(73) Assignee: TOYOTA JIDOSHA KABUSHIKI KAISHA, Toyota-shi, Aichi-ken (JP)

(21) Appl. No.: 13/581,551

(22) PCT Filed: Jul. 16, 2010
(86) PCT No.: PCT/JP2010/062084

§ 371 Date: Aug. 28, 2012

(51) Int. Cl. F02N 15/00

(52) U.S. Cl. CPC F02N 15/00
USPC 123/179.3

(57) ABSTRACT

A device for starting an engine includes a starter for starting the engine and an ECU for controlling the starter. The starter includes a pinion gear structured to engage with a ring gear coupled to a crankshaft of the engine, an actuator for moving the pinion gear to an engagement position with the ring gear, and a motor for rotating the pinion gear. The ECU can individually control each of the actuator and the motor. The ECU holds such a state that the motor is stopped and the actuator is driven during a stand-by period until a reference condition is satisfied after completion of start of the engine. Thus, when the engine stopped immediately after start, the engine can quickly be re-started.

### TECHNICAL FIELD

The present invention relates to an engine starting device and a vehicle incorporating the same and more particularly to control of a starting device capable of individually controlling an actuator for moving a pinion gear to a position of engagement with a ring gear coupled to a crankshaft of the engine and a motor for rotating the pinion gear.

### BACKGROUND ART

In recent years, in order to improve fuel efficiency or reduce exhaust emission, some cars having an internal combustion engine such as an engine include what is called an idling-stop function, in which an engine is automatically stopped while a vehicle stops and a driver operates a brake pedal, and the vehicle is automatically re-started, for example, by a driver's operation for re-start such as decrease in an amount of operation of a brake pedal to zero.

In this idling-stop, the engine may be re-started while an engine speed is relatively high. In such a case, with a conventional starter in which engagement of a pinion gear for rotating the engine and rotation of the pinion gear are caused by one drive command, the starter is driven after waiting until the engine speed sufficiently lowers, in order to facilitate engagement between the pinion gear and a ring gear of the engine. Accordingly, a time lag is caused between issuance of a request to re-start an engine and actual engine cranking, and the driver may feel uncomfortable.

In order to solve such a problem, Japanese Patent Laying-Open No. 2005-330813 (PTL 1) discloses a technique, with the use of a starter configured such that a pinion gear engagement operation and a pinion gear rotational operation can individually be controlled, for causing a pinion gear to perform a rotational operation prior to the pinion gear engagement operation when a re-start request is issued while rotation of an engine is being lowered immediately after a stop request is generated, and for re-starting the engine by performing the pinion gear engagement operation when a pinion gear rotation speed is in synchronization with an engine speed.

### CITATION LIST

### Patent Literature

PTL 1: Japanese Patent Laying-Open No. 2005-330813
PTL 2: Japanese Patent Laying-Open No. 2009-529114
PTL 3: Japanese Patent Laying-Open No. 2010-31851
PTL 4: Japanese Patent Laying-Open No. 2000-97139
PTL 5: Japanese Patent Laying-Open No. 2009-191843

### SUMMARY OF INVENTION

### Technical Problem

According to the technique described in Japanese Patent Laying-Open No. 2005-330813 (PTL 1), even when a re-start request is issued while rotation of an engine is being lowered immediately after a stop request is generated, the engine can be cranked without the need for waiting for lowering in the engine speed.

In such a state as before stabilization of a combustion state immediately after completion of start of the engine, for example, a driver's operation such as sudden engagement of a clutch may stop the engine. In such a case, when a second gear engagement operation and a second gear rotational operation by the motor are again performed at the time of re-start of the engine, a time period until re-start may become long.

The present invention was made to solve such problems, and an object of the present invention is to quickly re-start an engine when the engine stopped immediately after start, by using an engine starting device having a starter capable of individually controlling a second gear engagement operation and a second gear rotational operation.

### Solution to Problem

A device for starting an engine according to the present invention includes a starter for starting the engine and a controller for controlling the starter. The starter includes a second gear that can be engaged with a first gear coupled to a crankshaft of the engine, an actuator for moving the second gear to an engagement position with the first gear in a driven state, and a motor for rotating the second gear. The controller is capable of individually controlling each of the actuator and the motor and holds such a state that the motor is stopped and the actuator is driven during a stand-by period until a reference condition is satisfied after completion of start of the engine.

According to such a device for starting, each of the actuator and the motor can individually be controlled. During a stand-by period after completion of start of the engine, such a state that the motor is stopped but the actuator is driven, that is, such a state that the first gear and the second gear remain engaged with each other although the engine is not rotated by the starter, is held. Therefore, when the engine stopped immediately after start, it is not necessary again to engage the first gear and the second gear with each other so that the engine can quickly be re-started simply by driving the motor.

Preferably, the controller starts the engine by driving the motor in addition to the actuator when a rotation speed of the engine is lower than a reference speed during the stand-by period.

According to such a configuration, when a rotation speed of the engine becomes lower than a reference rotation speed after completion of start of the engine, that is, when the engine stopped, the motor is driven in addition to the actuator. Thus, engine stop after completion of start of the engine can be determined and the engine can be re-started.

Preferably, the controller further stops the actuator when the reference condition is satisfied without the rotation speed of the engine being lower than the reference speed.

According to such a configuration, when a reference condition is satisfied without a rotation speed of the engine being lower than a reference speed, that is, when an operation of the engine normally continues, the actuator can be stopped and a state of engagement between the first gear and the second gear can be canceled. Thus, continued drive of the actuator more than necessary can be suppressed and waste of power consumption can be prevented.

Preferably, the reference condition includes lapse of a first reference time period after completion of start of the engine.

According to such a configuration, based on the fact that the first reference time period has elapsed since completion of start of the engine, it can be determined that an operation of the engine normally continues.

Preferably, the device for starting is mounted on a vehicle. Then, the reference condition includes a vehicle speed exceeding a reference vehicle speed after completion of start of the engine.

According to such a configuration, when the device for starting an engine is mounted on a vehicle, based on the fact that a vehicle speed exceeds a reference vehicle speed, that is, the vehicle is running, it can be determined that an operation of the engine normally continues.

Preferably, the controller controls the starter by using a first mode in which the motor is driven before the actuator is driven and a second mode in which the first gear and the second gear are engaged with each other by means of the actuator before the motor is driven. In a case where start of the engine is necessary, the controller selects the second mode when a rotation speed of the engine is lower than a first reference value and selects the first mode when a rotation speed of the engine is intermediate between the first reference value and a second reference value greater than the first reference value.

According to such a configuration, when a rotation speed of the engine is lower than a first reference value, that is, when the rotation speed is low, the second gear is engaged with the first gear with the second gear remaining stopped (the second mode), and when a rotation speed of the engine is intermediate between the first reference value and a second reference value greater than the first reference value, that is, when the rotation speed is relatively high, the second gear can be engaged with the first gear while the second gear is rotated (the first mode). Thus, when the rotation speed is relatively high, a difference in speed between the first gear and the second gear can be made smaller. Therefore, even when the rotation speed is relatively high, the first gear and the second gear can smoothly be engaged with each other.

Preferably, while the first mode is selected, the controller causes the first gear and the second gear to be engaged with each other by driving the actuator when it is determined that synchronization between a rotation speed of the engine and a rotation speed of the motor at the time when an operation for engagement by the actuator is expected to complete is established. The controller determines that the synchronization is established when a difference between the rotation speed of the engine and the rotation speed of the motor at the time when the operation for engagement by the actuator is expected to complete is within a predetermined range.

According to such a configuration, in the first mode, when a difference between a rotation speed of the engine and a rotation speed of the motor at the time when the operation for engagement by the actuator is expected to complete is within a predetermined range, that is, when a difference in speed between the first gear and the second gear becomes small, the first gear and the second gear can be engaged with each other.

Preferably, the controller starts drive of the actuator at a time point calculated by subtracting an operation time period of the actuator from a time point when the synchronization is established.

According to such a configuration, start of drive of the actuator can be determined in consideration of an operation time period of the actuator. Therefore, difference in speed between the first gear and the second gear can be minimized.

Preferably, the controller starts drive of the motor based on completion of engagement between the first gear and the second gear while the second mode is selected.

According to such a configuration, in the second mode, start of the engine can begin while the first gear and the second gear are engaged with each other.

Preferably, while the first mode is selected, the controller stops the motor when timing to start drive of the actuator comes after lapse of a second reference time period.

According to such a configuration, even though the first mode has been selected, in a case where synchronization will no longer be established at the time of completion of the operation of the actuator, the engine can be started in such a state that the motor is stopped and the second gear is stopped.

Preferably, the actuator includes a solenoid. The actuator moves the second gear from a stand-by position to the engagement position with the first gear when the solenoid is excited and returns the second gear to the stand-by position when the solenoid is no longer excited.

According to such a configuration, the first gear and the second gear can be engaged with each other by exciting the solenoid and the engaged state can be canceled by not exciting the solenoid.

A vehicle according to the present invention includes an engine for generating driving force for running the vehicle, a starter for starting the engine, and a controller for controlling the starter. The starter includes a second gear that can be engaged with a first gear coupled to a crankshaft of the engine, an actuator for moving the second gear to an engagement position with the first gear in a driven state, and a motor for rotating the second gear. The controller is capable of individually controlling each of the actuator and the motor and holds such a state that the motor is stopped and the actuator is driven during a stand-by period until a reference condition is satisfied after completion of start of the engine.

Such a vehicle has a starter capable of individually controlling each of the actuator and the motor, and during a stand-by period after completion of start of the engine, such a state that the motor is stopped but the actuator is driven, that is, such a state that the first gear and the second gear remain engaged with each other although the engine is not rotated by the starter, is held. Therefore, when the engine stopped immediately after start, it is not necessary again to engage the first gear and the second gear with each other so that the engine can quickly be re-started simply by driving the motor.

### Advantageous Effects of Invention

According to the present invention, an engine starting device having a starter capable of individually controlling a pinion gear engagement operation and a pinion gear rotational operation can quickly re-start an engine when the engine stopped immediately after start.

### BRIEF DESCRIPTION OF DRAWINGS

FIG. 1 is an overall block diagram of a vehicle incorporating an engine starting device according to the present embodiment.

FIG. 2 is a diagram for illustrating transition of an operation mode of a starter according to the present embodiment.

FIG. 3 is a diagram for illustrating a drive mode in an engine start operation according to the present embodiment.

FIG. 4 is a diagram for illustrating details of a rotation mode.

FIG. 5 is a flowchart for illustrating details of operation mode setting control processing performed by an ECU according to the present embodiment.

### DESCRIPTION OF EMBODIMENTS

An embodiment of the present invention will be described hereinafter with reference to the drawings. In the description below, the same elements have the same reference characters allotted. Their label and function are also identical. Therefore, detailed description thereof will not be repeated.

[Structure of Engine Starting Device]

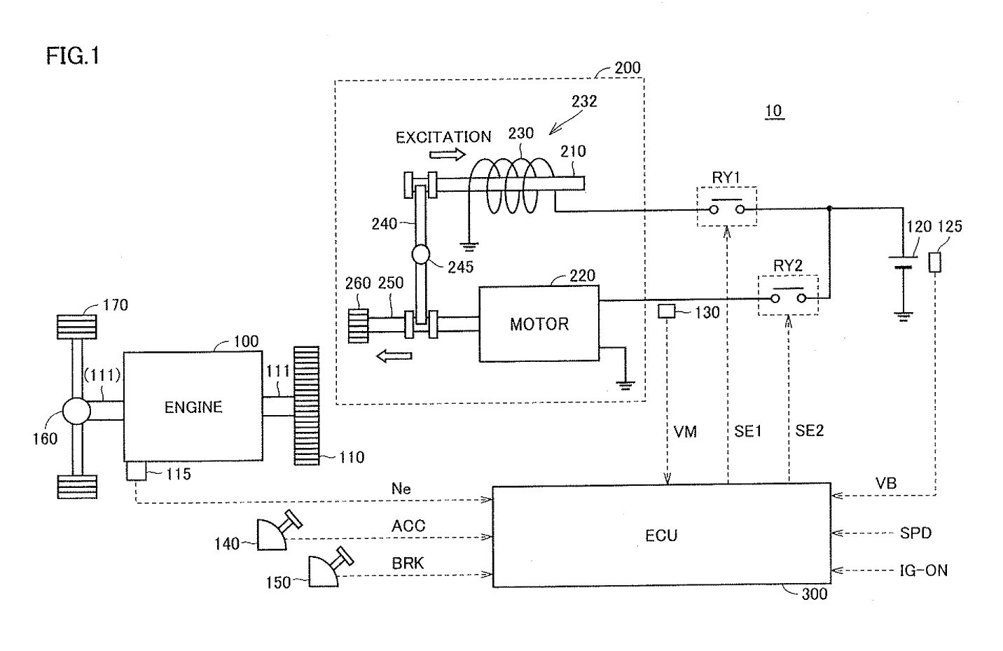

FIG. 1 is an overall block diagram of a vehicle 10 incorporating an engine starting device according to the present embodiment.

Referring to FIG. 1, vehicle 10 includes an engine 100, a battery 120, a starter 200, a control device (hereinafter also referred to as an ECU (Electronic Control Unit)) 300, and relays RY1, RY2. Starter 200 includes a plunger 210, a motor 220, a solenoid 230, a coupling portion 240, an output member 250, and a pinion gear 260.

Engine 100 generates driving force for running vehicle 10. A crankshaft 111 of engine 100 is connected to a drive wheel 170, with a powertrain 160 structured to include a clutch, a reduction gear, or the like being interposed.

Engine 100 is provided with a rotation speed sensor 115. Rotation speed sensor 115 detects a rotation speed Ne of engine 100 and outputs a detection result to ECU 300.

Battery 120 is an electric power storage element configured such that it can be charged and can discharge. Battery 120 is configured to include a secondary battery such as a lithium ion battery, a nickel metal hydride battery, a lead-acid battery, or the like. Alternatively, battery 120 may be implemented by a power storage element such as an electric double layer capacitor.

Battery 120 is connected to starter 200 with relays RY1, RY2 controlled by ECU 300 being interposed. Battery 120 supplies a supply voltage for driving to starter 200 as relays RY1, RY2 are closed. It is noted that a negative electrode of battery 120 is connected to a body earth of vehicle 10.

Battery 120 is provided with a voltage sensor 125. Voltage sensor 125 detects an output voltage VB of battery 120 and outputs a detection value to ECU 300.

Relay RY1 has one end connected to a positive electrode of battery 120 and the other end connected to one end of solenoid 230 within starter 200. Relay RY1 is controlled by a control signal SE1 from ECU 300 so as to switch between supply and cut-off of a supply voltage from battery 120 to solenoid 230.

Relay RY2 has one end connected to the positive electrode of battery 120 and the other end connected to motor 220 within starter 200. Relay RY2 is controlled by a control signal SE2 from ECU 300 so as to switch between supply and cut-off of a supply voltage from battery 120 to motor 220. In addition, a voltage sensor 130 is provided in a power line connecting relay RY2 and motor 220 to each other. Voltage sensor 130 detects a motor voltage VM and outputs a detection value to ECU 300.

As described above, supply of a supply voltage to motor 220 and solenoid 230 within starter 200 can individually be controlled by relays RY1, RY2.

Output member 250 is coupled to a rotation shaft of a rotor (not shown) within the motor, for example, by a straight spline or the like. In addition, pinion gear 260 is provided on an end portion of output member 250 opposite to motor 220. As relay RY2 is closed, the supply voltage is supplied from battery 120 so as to rotate motor 220. Then, output member 250 transmits the rotational operation of the rotor to pinion gear 260, to thereby rotate pinion gear 260.

As described above, solenoid 230 has one end connected to relay RY1 and the other end connected to the body earth. As relay RY1 is closed and solenoid 230 is excited, solenoid 230 attracts plunger 210 in a direction of arrow. Namely, solenoid 230 and plunger 210 constitute an actuator 232.

Plunger 210 is coupled to output member 250 with coupling portion 240 being interposed. As solenoid 230 is excited, plunger 210 is attracted in the direction of the arrow. Thus, coupling portion 240 of which fulcrum 245 is fixed moves output member 250 from a stand-by position shown in FIG. 1 in a direction reverse to a direction of operation of plunger 210, that is, a direction in which pinion gear 260 moves away from a main body of motor 220, to an engagement position with a ring gear 110 coupled to the crankshaft of engine 100. In addition, biasing force reverse to the arrow in FIG. 1 is applied to plunger 210 by a not-shown spring mechanism, and when solenoid 230 is no longer excited, it returns to the stand-by position.

As output member 250 thus operates in an axial direction as a result of excitation of solenoid 230, pinion gear 260 is engaged with ring gear 110 coupled to crankshaft 111 of engine 100. Then, as pinion gear 260 performs a rotational operation while pinion gear 260 and ring gear 110 are engaged with each other, engine 100 is cranked and started. Ring gear 110 is provided, for example, around an outer circumference of a flywheel of the engine.

Thus, in the present embodiment, actuator 232 for moving pinion gear 260 so as to be engaged with ring gear 110 provided around the outer circumference of the flywheel of engine 100 and motor 220 for rotating pinion gear 260 are individually controlled.

Though not shown in FIG. 1, a one-way clutch may be provided between output member 250 and a rotor shaft of motor 220 such that the rotor of motor 220 does not rotate due to the rotational operation of ring gear 110.

In addition, actuator 232 in FIG. 1 is not limited to the mechanism as above so long as it is a mechanism capable of transmitting rotation of pinion gear 260 to ring gear 110 and switching between a state that pinion gear 260 and ring gear 110 are engaged with each other and a state that they are not engaged with each other. For example, such a mechanism that pinion gear 260 and ring gear 110 are engaged with each other as a result of movement of the shaft of output member 250 in a radial direction of pinion gear 260 is also applicable.

ECU 300 includes a CPU (Central Processing Unit), a storage device, and an input/output buffer, none of which is shown, and receives input from each sensor or provides output of a control command to each piece of equipment. It is noted that control of these components is not limited to processing by software, and a part thereof may also be constructed by dedicated hardware (electronic circuitry) and processed.

ECU 300 receives a signal ACC indicating an amount of operation of an accelerator pedal 140 from a sensor (not shown) provided on accelerator pedal 140. ECU 300 receives a signal BRK indicating an operation of a brake pedal 150 from a sensor (not shown) provided on brake pedal 150. In addition, ECU 300 receives a start operation signal IG-ON issued in response to a driver's ignition operation or the like. Further, ECU 300 receives a vehicle speed signal SPD indicating a speed of the vehicle from a not-shown vehicle speed sensor. Based on such information, ECU 300 generates a signal requesting start of engine 100 and a signal requesting stop thereof and outputs control signal SE1, SE2 in accordance therewith, so as to control an operation of starter 200.

[Description of Operation Mode of Starter]

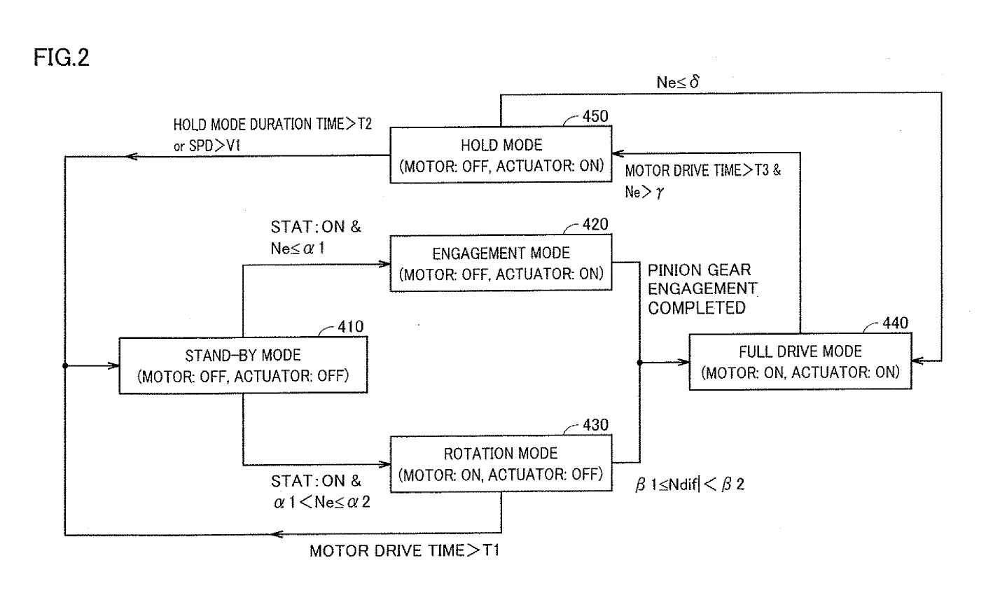

FIG. 2 is a diagram for illustrating transition of an operation mode of starter 200 in the present embodiment. Referring to FIGS. 1 and 2, the operation mode of starter 200 in the present embodiment includes a stand-by mode 410, an engagement mode 420, a rotation mode 430, a full drive mode 440, and a hold mode 450.

Stand-by mode 410 is a mode in which neither of actuator 232 and motor 220 in starter 200 is driven, that is, a mode in which an engine start request to starter 200 is not output. Stand-by mode 410 corresponds to an initial state of starter 200, and it is selected when drive of starter 200 is not necessary, for example, before an operation to start engine 100, after completion of start of engine 100, failure in starting engine 100, and the like.

Full drive mode 440 is a mode in which both of actuator 232 and motor 220 in starter 200 are driven. In this full drive mode 440, motor 220 performs an operation for rotating pinion gear 260 while pinion gear 260 and ring gear 110 are engaged with each other. Thus, engine 100 is actually cranked and the operation for start is started.

As described above, starter 200 in the present embodiment can individually drive each of actuator 232 and motor 220. Therefore, in a process of transition from stand-by mode 410 to full drive mode 440, there are a case where actuator 232 is driven prior to drive of motor 220 (that is, corresponding to engagement mode 420) and a case where motor 220 is driven prior to drive of actuator 232 (that is, corresponding to rotation mode 430).

Engagement mode 420 is a mode where only actuator 232 is driven and motor 220 is not driven. This mode is selected when pinion gear 260 and ring gear 110 can be engaged with each other even while pinion gear 260 remains stopped. Specifically, while engine 100 remains stopped or while rotation speed Ne of engine 100 is sufficiently low (Ne≦a first reference value α1), this engagement mode 420 is selected.

Then, in response to completion of engagement between pinion gear 260 and ring gear 110, the operation mode makes transition from engagement mode 420 to full-drive mode 440.

It is noted that determination as to whether engagement between pinion gear 260 and ring gear 110 has been completed or not can be made also based on a detection signal from a sensor (not shown) provided to detect a position of output member 250. Engagement in a certain period, however, is likely because of rotation of engine 100 or rotation of pinion gear 260. Therefore, determination that engagement between pinion gear 260 and ring gear 110 has been completed can be made also based on lapse of a predetermined time period since start of drive of actuator 232, without using a sensor. By doing so, arrangement of a sensor for detecting a position of output member 250 can be omitted, to thereby avoid a complicated system and to achieve reduction in cost.

Meanwhile, rotation mode 430 is a mode where only motor 220 is driven and actuator 232 is not driven. This mode is selected, for example, when a request for re-start of engine 100 is output immediately after stop of engine 100 is requested and when rotation speed Ne of engine 100 is relatively high (α1<Ne≦a second reference value α2).

Thus, when rotation speed Ne of engine 100 is high, difference in speed between pinion gear 260 and ring gear 110 is great while pinion gear 260 remains stopped, and engagement between pinion gear 260 and ring gear 110 may become difficult. Therefore, in rotation mode 430, only motor 220 is driven prior to drive of actuator 232, so that a rotation speed of ring gear 110 and a rotation speed of pinion gear 260 are in synchronization with each other. Then, in response to difference between the rotation speed of ring gear 110 and the rotation speed of pinion gear 260 being sufficiently small, actuator 232 is driven and ring gear 110 and pinion gear 260 are engaged with each other. Then, the operation mode makes transition from rotation mode 430 to full drive mode 440.

It is noted that, when synchronization between a rotation speed of ring gear 110 and a rotation speed of pinion gear 260 was unsuccessful, the operation mode returns to stand-by mode 410 after a motor drive time period exceeds a prescribed time period (T1). Thereafter, in accordance with rotation speed Ne of engine 100 at that time, engagement mode 420 or rotation mode 430 is selected and a starting operation is again performed.

In the case of full drive mode 440, the operation mode makes transition from full drive mode 440 to hold mode 450 in response to completion of start of engine 100 and start of a self-sustained operation of engine 100.

In this hold mode 450, drive of motor 220 is stopped after start of engine 100 is completed. Until a certain time period elapses, however, actuator 232 remains driven and a state of engagement between pinion gear 260 and ring gear 110 is maintained. Necessity of such a hold mode will be described below.

Normally, when start of the engine is completed, the starter for starting the engine is generally set to a non-driven state.

Immediately after start of the engine, in particular when an engine temperature is still low such as when an operation of a vehicle is started, however, a combustion state of the engine may not sufficiently be stable. In addition, immediately after start of the engine, it is also possible that a driver suddenly engages the clutch or sets a transmission to an inappropriate shift position. In such a case, the engine may again stop immediately after start of the engine.

In such a case that the engine stopped immediately after start of the engine, when the engine is re-started by using any of the rotation mode and the engagement mode as described above, each of the pinion gear engagement operation by the actuator and the pinion gear rotational operation by the motor should be performed and re-start of the engine may take time.

Therefore, by maintaining a state of engagement between the pinion gear and the ring gear for a certain time period after completion of start of the engine as in the present embodiment, the engine can quickly be re-started in spite of undesired engine stop immediately after start of the engine.

In a case where engine 100 stopped for the reasons as described above, when engine rotation speed Ne is equal to or lower than a threshold value δ while this hold mode 450 is selected, the operation mode again makes transition to full-drive mode 440. Here, since pinion gear 260 has already been engaged with ring gear 110, engine 100 can immediately be cranked by driving motor 220.

It is noted that a condition for transition from hold mode 450 to full-drive mode 440 may include such conditions as a shift position and a clutch engagement state, in addition to a condition of engine rotation speed Ne.

On the other hand, when the engine does not stop after start of the engine, continued excitation of solenoid 230 may lead to unnecessary power consumption. Therefore, when a prescribed time period (T2) elapses without stop of engine 100, excitation of solenoid 230 is stopped and the operation mode returns to stand-by mode 410. Thus, a non-engaged state is set and plunger 210 is returned to the stand-by position.

In addition, when running of vehicle 10 normally starts without lapse of prescribed time period T2 above, it is less likely that the engine stops. Therefore, the operation mode may make transition to stand-by mode 410 based on the fact that vehicle speed signal SPD from the vehicle speed sensor (not shown) is greater than a prescribed value V1.

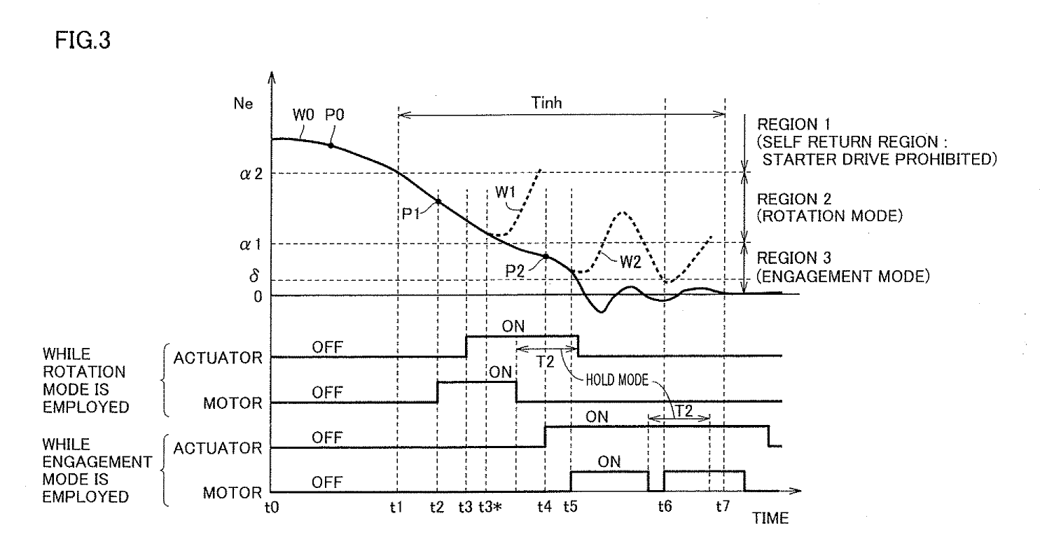

FIG. 3 is a diagram for illustrating a drive mode (the engagement mode, the rotation mode, and the hold mode) in an engine start operation in the present embodiment.

In FIG. 3, the abscissa indicates time and the ordinate indicates rotation speed Ne of engine 100 and a state of drive of actuator 232 and motor 220 when the engagement mode is employed and the rotation mode is employed.

Referring to FIGS. 1 and 3, a case where, at a time t0, for example, a condition that the vehicle stops and the driver operates brake pedal 150 is satisfied and consequently a request to stop engine 100 is generated and combustion in engine 100 is stopped is considered. Here, unless engine 100 is re-started, rotation speed Ne of engine 100 gradually lowers as shown with a solid line W0 and finally rotation of engine 100 stops.

Then, a case where, for example, an amount of the driver's operation of brake pedal 150 attains to zero while rotation speed Ne of engine 100 is lowering, and thus a request to re-start engine 100 is generated is considered. Here, categorization into three regions based on rotation speed Ne of engine 100 is made.

A first region (region 1) refers to a case where rotation speed Ne of engine 100 is higher than second reference value α2, and for example, such a state that a request for re-start is generated at a point P0 in FIG. 3.

This region 1 is a region where engine 100 can be started by a fuel injection and ignition operation without using starter 200 because rotation speed Ne of engine 100 is sufficiently high, that is, a region where engine 100 can return by itself. Therefore, in region 1, drive of starter 200 is prohibited. It is noted that second reference value α2 described above may be restricted depending on a maximum rotation speed of motor 220.

A second region (region 2) refers to a case where rotation speed Ne of engine 100 is intermediate between first reference value α1 and second reference value α2, and such a state that a request for re-start is generated at a point P1 in FIG. 3.

This region 2 is a region where rotation speed Ne of engine 100 is relatively high, although engine 100 cannot return by itself. In this region, the rotation mode is selected as described with reference to FIG. 2.

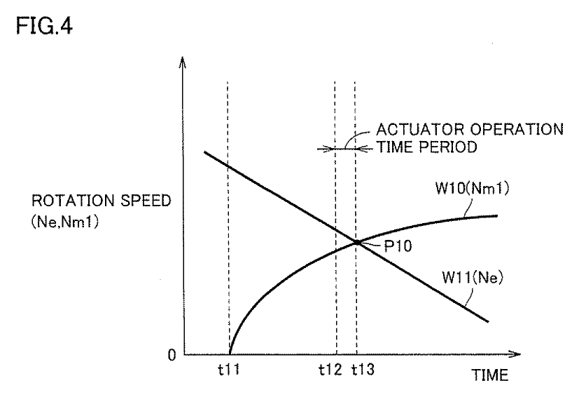

Here, details of the rotation mode will be described with reference to FIG. 4. In FIG. 4, the abscissa indicates time and the ordinate indicates rotation speed Ne of engine 100 and a rotation speed Nm1 of motor 220 converted to a crankshaft speed.

Referring to FIGS. 1 and 4, such a state that a request to start engine 100 is issued at a time t11 and the rotation mode is selected based on rotation speed Ne of engine 100 is considered. When it is determined that a re-start request has not been issued, rotation speed Ne of engine 100 decreases with time, for example, as shown with a curve W11 in FIG. 4.

In addition, since the rotation mode has been selected, drive of motor 220 of starter 200 is started at time t11. Then, a rotation speed of motor 220 increases with time. It is noted that, in FIG. 4, rotation speed Nm1 obtained by converting a rotation speed of output member 250 to a rotation speed of crankshaft 111 of engine 100 based on a gear ratio between pinion gear 260 and ring gear 110 is shown with a line W10 in FIG. 4.

Then, at a point P10 at a time t13, rotation speed Ne of engine 100 is in synchronization with rotation speed Nm1 of the motor converted to a crankshaft speed. Actuator 232 is driven such that pinion gear 260 reaches a position of engagement with ring gear 110 at time t13, in consideration of an operation time period of plunger 210 since application of a voltage to solenoid 230. For example, drive of actuator 232 is started at a time t12 calculated by subtracting an operation time period of plunger 210 from time t13.

Namely, drive of actuator 232 is started at the time point (time t12) when it is determined that synchronization at the time when engagement of pinion gear 260 is expected to complete, between rotation speed Ne of engine 100 and rotation speed Nm1 of the motor converted to a crankshaft speed, is established, in consideration of an operation time period of plunger 210.

Referring again to FIG. 3, when a request to re-start engine 100 is generated at a time t2, motor 220 is initially driven. Thus, pinion gear 260 starts to rotate. Then, at a time t3 when it is determined that synchronization at the time when engagement is expected to complete, between rotation speed Ne of engine 100 and a rotation speed of pinion gear 260 converted to a crankshaft 111 speed, is established, actuator 232 is driven. Then, when ring gear 110 and pinion gear 260 are engaged with each other (a time t3*), engine 100 is cranked by motor 220 and rotation speed Ne of engine 100 increases as shown with a dashed line W1.

Thereafter, when engine 100 resumes the self-sustained operation, such a state that drive of motor 220 is stopped but actuator 232 is driven is maintained. Namely, the operation mode is set to the hold mode. As described above, this state is canceled when prescribed time period T2 elapsed or when a vehicle speed is detected.

A third region (region 3) refers to a case where rotation speed Ne of engine 100 is lower than first reference value α1, and for example, such a state that a request for re-start is generated at a point P2 in FIG. 3.

This region 3 is a region where rotation speed Ne of engine 100 is low and pinion gear 260 and ring gear 110 can be engaged with each other without synchronizing pinion gear 260. In this region, the engagement mode is selected as described with reference to FIG. 2.

When a request to re-start engine 100 is generated at a time t4, actuator 232 is initially driven. Thus, pinion gear 260 is pushed toward ring gear 110. Thereafter, in response to completion of engagement between ring gear 110 and pinion gear 260 or lapse of a prescribed time period, motor 220 is driven (a time t5 in FIG. 3). Thus, engine 100 is cranked and rotation speed Ne of engine 100 increases.

Thereafter, when engine 100 resumes the self-sustained operation, the operation mode makes transition to the hold mode as in the description of the rotation mode.

Here, for example, a case where an operation of engine 100 again stopped due to a driver's sudden clutch operation and engine speed Ne lowered as shown with a curve W2 after engine 100 performs the self-sustained operation is considered. In the present embodiment, when engine rotation speed Ne is lower than prescribed speed δ while the hold mode continues (a time t6 in FIG. 3) in such a case, the operation mode makes transition to the full-drive mode and motor 220 is driven. In the hold mode, since a state of engagement between pinion gear 260 and ring gear 110 is maintained for a certain period as described above, simply by driving motor 220, engine 100 is immediately cranked and engine rotation speed Ne increases.

By thus controlling re-start of engine 100 by using starter 200 in which actuator 232 and motor 220 can individually be driven, engine 100 can be re-started in a shorter period of time than in a case of the conventional starter where an operation to re-start engine 100 was prohibited during a period (Tinh) from a rotation speed at which return of engine 100 by itself was impossible (time t1 in FIG. 3) to stop of engine 100 (a time t7 in FIG. 3). Then, by adopting the hold mode in which engagement between pinion gear 260 and ring gear 110 is maintained for a certain period after completion of start of engine 100, engine 100 can quickly be re-started when engine 100 stopped immediately after start of the engine.

[Description of Operation Mode Setting Control]

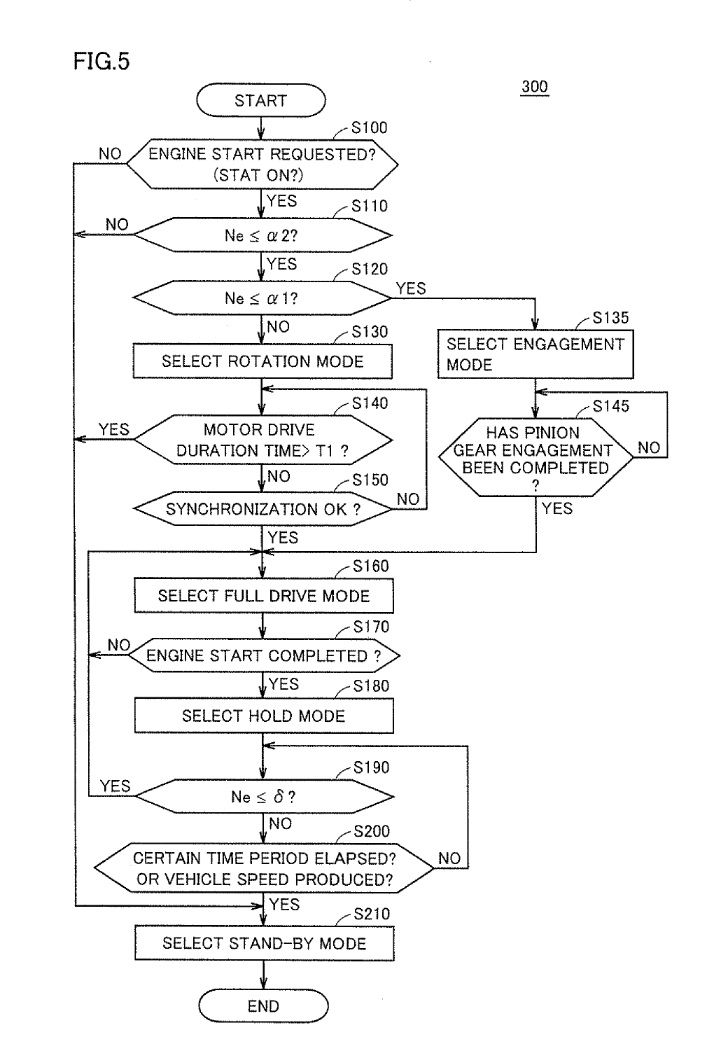

FIG. 5 is a flowchart for illustrating details of operation mode setting control processing performed by ECU 300 in the present embodiment. The flowchart shown in FIG. 5 is realized by executing a program stored in advance in ECU 300 in a prescribed cycle. Alternatively, regarding some steps, processing can also be performed by constructing dedicated hardware (electronic circuitry).

Referring to FIGS. 1 and 5, in step (hereinafter the step being abbreviated as S) 100, ECU 300 determines whether start of engine 100 has been requested or not. Namely, whether to start engine 100 or not is determined.

When start of engine 100 has not been requested (NO in S100), the process proceeds to S210 and ECU 300 selects the stand-by mode because an operation to start engine 100 is not necessary.

When start of engine 100 has been requested (YES in S100), the process proceeds to S110 and ECU 300 then determines whether or not rotation speed Ne of engine 100 is equal to or smaller than second reference value α2.

When rotation speed Ne of engine 100 is greater than second reference value α2 (NO in S110), this case corresponds to region 1 in FIG. 3 where engine 100 can return to self-sustained operation by itself. Therefore, ECU 300 causes the process to proceed to S210 and selects the stand-by mode.

When rotation speed Ne of engine 100 is equal to or smaller than second reference value α2 (YES in S110), ECU 300 further determines whether or not rotation speed Ne of engine 100 is equal to or smaller than first reference value α1.

When rotation speed Ne of engine 100 is equal to or smaller than first reference value α1 (YES in S120), this case corresponds to region 1 in FIG. 3. Therefore, the process proceeds to S135 and ECU 300 selects the engagement mode. Then, ECU 300 outputs control signal SE1 so as to close relay RY1, and thus actuator 232 is driven. Here, motor 220 is not driven.

Then, ECU 300 determines in S145 whether engagement between pinion gear 260 and ring gear 110 has been completed or not. This determination may be made based on position detection using a sensor as described above or based on lapse of a prescribed time period.

When engagement between pinion gear 260 and ring gear 110 has not been completed (NO in S145), the process returns to S145 and ECU 300 waits until engagement between pinion gear 260 and ring gear 110 is completed.

On the other hand, when engagement between pinion gear 260 and ring gear 110 is completed (YES in S145), the process proceeds to S160 and ECU 300 selects the full-drive mode.

On the other hand, when rotation speed Ne of engine 100 is greater than first reference value α1 (NO in S120), this case corresponds to region 2 in FIG. 3 and the process proceeds to S130 and ECU 300 selects the rotation mode. Then, ECU 300 outputs control signal SE2 so as to close relay RY2, and thus motor 220 is driven. Here, actuator 232 is not driven.

Then, ECU 300 determines in S140 whether a duration during which motor 220 is driven has exceeded prescribed time period T1 or not.

When the duration during which motor 220 is driven has exceeded prescribed time period T1 (YES in S140), ECU 300 determines that synchronization between pinion gear 260 and ring gear 110 has not been established and engine 100 could not be started, causes the process to proceed to S210, and once selects the stand-by mode. Thereafter, the processing from S100 is again performed and the engine start processing is performed.

When the duration during which motor 220 is driven has not exceeded prescribed time period T1 (NO in S140), the process proceeds to S150 and ECU 300 determines whether or not synchronization at the time when an operation of actuator 232 is expected to complete, between a rotation speed Ne of engine 100 and rotation speed Nm of motor 220 converted to a crankshaft speed, is established. Determination of establishment of synchronization is specifically made based on whether or not a relative speed Ndiff between rotation speed Ne of engine 100 and rotation speed Nm of motor 220 converted to a crankshaft speed (Ne−Nm) is in between prescribed threshold values (0≦β1≦Ndiff<β2). Though determination of establishment of synchronization may be made based on whether or not an absolute value of relative rotation speed Ndiff is smaller than a threshold value β (|Ndiff|<β), engagement is more preferably carried out while rotation speed Ne of engine 100 is higher than rotation speed Nm of motor 220.

When it is determined that synchronization has not been established (NO in S150), the process returns to S140 and ECU 300 waits for establishment of synchronization.

When it is determined that synchronization has been established (YES in step 5150), ECU 300 determines that synchronization has been established, causes the process to proceed to S160, and selects the full-drive mode.

In S160, ECU 300 drives both of actuator 232 and motor 220 and starts to crank engine 100.

Then, in S170, ECU 300 determines whether start of engine 100 has been completed or not. Determination of completion of start of engine 100 may be made, for example, based on whether or not the engine rotation speed is greater than a threshold value γ indicating the self-sustained operation after lapse of a prescribed time period since start of drive of motor 220.

When start of engine 100 has not been completed (NO in S170), the process returns to S160 and cranking of engine 100 is continued.

When start of engine 100 has been completed (YES in S170), the process proceeds to S180 and ECU 300 selects the hold mode and stops motor 220 while maintaining pinion gear 260 in the engaged state.

Then, ECU 300 determines in S190 whether or not engine rotation speed Ne is equal to or smaller than prescribed threshold value δ, that is, whether or not the self-sustained operation of engine 100 has stopped after completion of start of engine 100.

When engine rotation speed Ne is equal to or smaller than prescribed threshold value δ (YES in S190), the process returns to S160 and ECU 300 selects the full-drive mode and drives motor 220 while pinion gear 260 remains engaged with ring gear 110, to thereby re-start engine 100.

On the other hand, when engine rotation speed Ne is greater than prescribed threshold value δ (NO in S190), ECU 300 determines that the self-sustained operation of engine 100 is continuing and causes the process to proceed to S200.

ECU 300 determines in S200 whether duration of the self-sustained operation of engine 100 has exceeded a predetermined certain time period or whether a vehicle speed is produced as vehicle 10 runs.

When a certain time period has not been exceeded and production of a vehicle speed has not been confirmed either (NO in S200), the process returns to S190 and the processing in S190 and/or S200 is repeated.

When a certain time period has been exceeded or production of a vehicle speed has been confirmed (YES in S200), the process proceeds to S210, and ECU 300 selects the stand-by mode and stops both of actuator 232 and motor 220.

Though not shown in FIG. 5, when the self-sustained operation of the engine is not started in spite of lapse of a prescribed time period while the engine is being cranked in S160, for example, due to shortage of fuel or failure of an igniter, the operation mode may return to the stand-by mode, determining that there is possibility of failure.

As a result of control in accordance with the processing as above, for a certain time period after completion of start of the engine, such a state that the motor is stopped but the pinion gear and the ring gear are engaged with each other is maintained. Thus, when the engine stopped due to a driver's operation or the like immediately after completion of start of the engine, the engine can be cranked without performing an operation for engaging the pinion gear and hence the engine can quickly be re-started.

It is noted that “ring gear 110” and “pinion gear 260” in the present embodiment represent the “first gear” and the “second gear” in the present invention, respectively. In addition, the “rotation mode” and the “engagement mode” in the present embodiment represent the “first mode” and the “second mode” in the present invention, respectively.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

10 vehicle; 100 engine; 110 ring gear; 111 crankshaft; 115 rotation speed sensor; 120 battery; 125, 130 voltage sensor; 140 accelerator pedal; 150 brake pedal; 160 powertrain; 170 drive wheel; 200 starter; 210 plunger; 220 motor; 230 solenoid; 232 actuator; 240 coupling portion; 245 fulcrum; 250 output member; 260 pinion gear; 300 ECU; 410 stand-by mode; 420 engagement mode; 430 rotation mode; 440 full-drive mode; 450 hold mode; and RY1, RY2 relay.

1. A device for starting an engine, comprising:
a starter for starting said engine; and
a controller for controlling said starter,
said starter including
a second gear that can be engaged with a first gear coupled to a crankshaft of said engine,
an actuator for moving said second gear to an engagement position with said first gear in a driven state, and
a motor for rotating said second gear,
said controller being capable of individually controlling each of said actuator and said motor and holding such a state that said motor is stopped and said actuator is driven during a stand-by period until a reference condition is satisfied a duration of a self-sustained operation exceeds a first reference time period after completion of start of said engine.

2. The device for starting an engine according to claim 1, wherein
said controller starts said engine by driving said motor in addition to said actuator when a rotation speed of said engine is lower than a reference rotation speed during said stand-by period.

3. The device for starting an engine according to claim 2, wherein
said controller further stops said actuator when said reference condition is satisfied a state of continued said self-sustained operation is established without the rotation speed of said engine being lower than said reference rotation speed.

4. (canceled)

5. The device for starting an engine according to claim 1, wherein
said device for starting is mounted on a vehicle, and
said reference condition a state of continued said self-sustained operation includes a vehicle speed exceeding a reference vehicle speed after completion of start of said engine.

6. The device for starting an engine according to claim 1, wherein
said controller controls said starter by using a first mode in which said motor is driven before said actuator is driven and a second mode in which said first gear and said second gear are engaged with each other by means of said actuator before said motor is driven, and
in a case where start of said engine is necessary, said controller selects said second mode when a rotation speed of said engine is lower than a first reference value and selects said first mode when a rotation speed of said engine is intermediate between said first reference value and a second reference value greater than said first reference value.

7. The device for starting an engine according to claim 6, wherein
while said first mode is selected, said controller causes said first gear and said second gear to be engaged with each other by driving said actuator when it is determined that synchronization between a rotation speed of said engine and a rotation speed of said motor at time when an operation for engagement by said actuator is expected to complete is established, and determines that said synchronization is established when a difference between the rotation speed of said engine and the rotation speed of said motor at the time when the operation for engagement by said actuator is expected to complete is within a predetermined range.

8. The device for starting an engine according to claim 7, wherein
said controller starts drive of said actuator at a time point calculated by subtracting an operation time period of said actuator from a time point when said synchronization is established.

9. The device for starting an engine according to claim 6, wherein
said controller starts drive of said motor based on completion of engagement between said first gear and said second gear while said second mode is selected.

10. The device for starting an engine according to claim 6, wherein
while said first mode is selected, said controller stops said motor when timing to start drive of said actuator comes after lapse of a second reference time period since start of drive of said motor.

11. The device for starting an engine according to claim 1, wherein
said actuator includes a solenoid, and
said actuator moves said second gear from a stand-by position to the engagement position with said first gear when said solenoid is excited and returns said second gear to said stand-by position when said solenoid is no longer excited.

12. A vehicle, comprising:
an engine for generating driving force for running said vehicle;
a starter for starting said engine; and
a controller for controlling said starter,
said starter including
a second gear that can be engaged with a first gear coupled to a crankshaft of said engine,
an actuator for moving said second gear to an engagement position with said first gear in a driven state, and
a motor for rotating said second gear,
said controller being capable of individually controlling each of said actuator and said motor and holding such a state that said motor is stopped and said actuator is driven during a stand-by period until a reference condition is satisfied a duration of a self-sustained operation exceeds a first reference time period after completion of start of said engine.

13. (canceled)

14. A device for starting an engine, comprising:
a starter for starting said engine; and
a controller for controlling said starter,
said starter including
a second gear that can be engaged with a first gear coupled to a crankshaft of said engine,
an actuator for moving said second gear to an engagement position with said first gear in a driven state, and
a motor for rotating said second gear,
said controller being capable of individually controlling each of said actuator and said motor and holding such a state that said motor is stopped and said actuator is driven even though a self-sustained operation of said engine continues after completion of start of said engine.

15. The device for starting an engine according to claim 2, wherein
said controller controls said starter by using a first mode in which said motor is driven before said actuator is driven and a second mode in which said first gear and said second gear are engaged with each other by means of said actuator before said motor is driven, and
in a case where start of said engine is necessary, said controller selects said second mode when a rotation speed of said engine is lower than a first reference value and selects said first mode when a rotation speed of said engine is intermediate between said first reference value and a second reference value greater than said first reference value.

16. The device for starting an engine according to claim 3, wherein
said controller controls said starter by using a first mode in which said motor is driven before said actuator is driven and a second mode in which said first gear and said second gear are engaged with each other by means of said actuator before said motor is driven, and
in a case where start of said engine is necessary, said controller selects said second mode when a rotation speed of said engine is lower than a first reference value and selects said first mode when a rotation speed of said engine is intermediate between said first reference value and a second reference value greater than said first reference value.

17. The device for starting an engine according to claim 5, wherein
said controller controls said starter by using a first mode in which said motor is driven before said actuator is driven and a second mode in which said first gear and said second gear are engaged with each other by means of said actuator before said motor is driven, and
in a case where start of said engine is necessary, said controller selects said second mode when a rotation speed of said engine is lower than a first reference value and selects said first mode when a rotation speed of said engine is intermediate between said first reference value and a second reference value greater than said first reference value.
